(19) United States
(12) Patent Application Publication
(10) Pub. No.: US 2014/0320513 A1
(43) Pub. Date: Oct. 30, 2014

(54) IMAGE DISPLAY APPARATUS AND IMAGE DISPLAY METHOD

(71) Applicant: Hiroshi Ogi, Kyoto (JP)

(72) Inventor: Hiroshi Ogi, Kyoto (JP)

(21) Appl. No.: 14/366,544

(22) PCT Filed: May 29, 2012
(86) PCT No.: PCT/JP2012/003487

§ 371 Date: Jun. 18, 2014

(30) Foreign Application Priority Data
Dec. 28, 2011 (JP) 2011-287966

(51) Int. Cl. G06T 7/00; G06K 9/00; G09G 5/30

(52) U.S. Cl. CPC G06T 7/0012; G09G 5/30; G06K 9/0014
USPC 345/581

(57) ABSTRACT

In a technique for displaying images of recess portions formed on a sample holding plate, an image display apparatus or an image display method is provided which has a displaying function which makes it possible for a user to compare and observe the images from various perspectives. From a total image obtained by shooting a micro plate as a whole, areas corresponding to wells are cut out. Image processing, such as color coding and contour enhancement, is performed on images of the wells based on classification results obtained using a classification criterion designated by the user, thereby forming material images. The material images are arranged in such an arrangement in accordance with the sequence on the micro plate, thereby forming an image for displaying. Classification results obtained using different classification criteria are displayed side by side, which makes it easy to compare and observe from different perspectives.

### TECHNICAL FIELD

The present invention relates to an image display apparatus and an image display method for performing predetermined image processing of an image of a recess portion of a sample holding plate and for displaying an image which reflects a result of the image processing.

### BACKGROUND ART

In an experiment in the field of medicines or bio science, liquid (such as culture liquid), a culture medium or the like is injected into each well of a plate-like instrument which has a number of recess portions which are called “wells” for instance, and cultured cells or the like are observed. Such an instrument is called a micro plate, a micro titer plate, etc. In technologies of this type, a method to cause fluorescent emission of a particular molecule by for instance pre-processing of a sample, using a reagent, etc. is conventionally applied. Over the recent years, as a simple and low-cost method which does not use a reagent, a technique of analyzing and displaying an original image using an image processing technique has been studied. For example, the image processing system according to Patent Document 1 captures images of a plurality of living cells which serve as samples and displays an image which is colored in accordance with the feature value of a cell region which is recognized by analyzing each captured image.

### ANTECEDENT TECHNICAL DOCUMENT

### Patent Document

Patent Document 1 JP2006-350740A

### SUMMARY OF THE INVENTION

### Technical Problem

The conventional technique described above handles an image of a sample cultured in two dimensions which is captured at such a high resolution which allows one to recognize individual cells. Meanwhile, for the purpose of an experiment which resembles an in-vivo condition, observation of a cell cluster cultured in three dimensions is sometimes necessary. In such a situation, information regarding the cell cluster is more important than information regarding individual cells. Further, a criterion for a method of evaluating a cell cluster level image has not been established. Therefore, there is a strong demand for an apparatus which can analyze an image in accordance with a predetermined rule and which is equipped with a displaying function which permits a user to observe and compare an image from various aspects. However, such an apparatus with a feature satisfying the requirement above has not been realized by conventional techniques, including the technique described in Patent Document 1 above.

The invention was made in light of the problem described above, and therefore, an object of the invention is to provide an image display apparatus of or an image display method for displaying an image which satisfies the user requirement described above and which is used in a technique for displaying an image of a recess portion of a sample holding plate.

### Solution to Problem

To achieve the object above, an aspect of the invention is directed to an image display apparatus which displays images of a plurality of recess portions for holding samples which are arranged on a sample holding plate, comprising: an image processor which creates material images by treating an original image obtained by imaging one of the recess portions with image processing for attaching visual information corresponding to the content of the original image to the original image and creates an image for displaying in which a plurality of the material images which are different from each other are arranged; and a display element which displays the image for displaying.

To achieve the object above, a different aspect of the invention is directed to an image display method for displaying images of a plurality of recess portions for holding samples which are arranged on a sample holding plate, comprising: an image creating step of creating material images by treating an original image obtained by imaging one of the recess portions with image processing for attaching visual information corresponding to the content of the original image to the original image, and of creating an image for displaying in which a plurality of the material images which are different from each other are arranged within a same frame; and a displaying step of displaying the image for displaying.

In these aspects of the invention, the image for displaying contains at least one of (1) a set of the plurality of material images obtained by treating a plurality of the original images each of which corresponds to each recess portion and which are different from each other with the same image processing and (2) a set of the plurality of material images obtained by treating the same original image with different image processing. Thus, as the image in which the plurality of material images to which the visual information based upon the image processing has been attached are arranged is presented, the invention provides the image display apparatus or the image display method which satisfies a user's demand to compare the images of the recess portions from various perspectives. That is, as the image in which the plurality of material images (1) above are arranged is displayed, the samples created under the different conditions can be compared and observed under the same condition. Further, as the image in which the plurality of material images (2) above are arranged is displayed, the same sample can be compared and observed from different perspectives at the same time.

The means which attaches the visual information to the material image may for instance be color coding, filling in, change of the brightness, contour enhancement, attachment of a hem or pointer or attachment of text information, or combination of these.

In the invention, for example, the image for displaying may be created which corresponds to a user's command which demands at least one of selection of the material images and selection of the content of the image processing. This structure makes it possible to appropriately display various images which meet user's diverse requirements and efficiently help user's work.

In the image display apparatus described above, the image processor may comprise for instance: a specific segment detector which detects a specific segment exhibiting a particular optical characteristic within the original image; a feature value calculator which calculates a feature value of the detected specific segment; and a visual information attaching part which attaches to the original image the visual information corresponding to the calculated feature value. This makes it possible to present to a user the image for displaying in which it is easy to distinguish the part exhibiting a particular characteristic contained within the image (specific segment) from other parts.

In this case, the visual information attaching part may attach the visual information which corresponds to the feature value calculated as for the specific segment to a location which corresponds to the specific segment within the original image. This makes it easy for a user to understand the distribution of such specific segments and compare the states of the distribution among the plurality of material images.

In the invention, for instance, the image for displaying may be created which contains the plurality of material images which are obtained by attaching the visual information based upon the mutually different feature value to the same original image. Since this realizes simultaneous displaying of the material images obtained by processing one sample from different perspectives, it is possible for a user to more efficiently observe the sample.

Alternatively, for example, the image for displaying may be crated in which the plurality of material images corresponding to the recess portions according to the sequence of the mutually different recess portions on the sample holding plate. This makes it easy for a user to understand the relationship among thus displayed material images, and hence, efficiently compare and observe.

Alternatively, for instance, a magnification rate for displaying the material images within the image for displaying may be changed and set, and the visual information to attach to the material images in accordance with the set magnification rate may be changed. This makes it possible to present the image for displaying which a user can easily visually recognize.

Alternatively, for example, the image for displaying may be created which contains the plurality of material images which are obtained by treating the same single partial area within the same original image with different image processing. Depending upon the purpose of observation, a user may want to see only a partial area of an original image. In such an instance, when the plurality of material images corresponding to the partial area of the original image are indicative of the same area, a user is more efficiently assisted in performing observation.

Alternatively, for example, the image for displaying may be created which contains the material images and text information concerning the contents of the material images. This makes it possible to provide a user with more detailed information regarding the contents of the images.

Alternatively, for example, the invention may comprise an imager which makes an image capture element move relative to and scan the sample holding plate and accordingly captures the original image. In thus structured image display apparatus, it is possible to complete the series of processing from capturing of the original image through image processing and displaying of the original image within the single apparatus. Further, since a the image capture element moves relative to and scans the sample holding plate and the sample holding plate is shot in a wide range at a high resolution, it is possible to present a high-resolution image to a user.

Further, in the invention, an image of the recess portion, which holds transparent liquid or gel containing a cell or microorganism as the sample, may be used as the original image for instance. An experiment using such sample often includes a step of creating a plurality of samples under different conditions and comparing differences among the samples. When the invention is applied to observation of such samples, it is possible to greatly simplify user's work and make the user's work efficient.

### Advantageous Effects of Invention

According to the invention, a user is presented the image for displaying which contains the plurality of material images obtained by treating the original images of the recess portions of the sample holding plate holding the samples with the predetermined image processing, which makes it possible to satisfy a user's demand for an image which is suitable to compare and observe the samples.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1A is a drawing which shows a schematic structure of the image display apparatus according to an embodiment of the invention.

FIG. 1B is a drawing which shows an example of the shape of a well.

FIG. 2A is a drawing which shows a more detailed structure of an image capture part.

FIG. 2B is a drawing of scanning by an image capture unit.

FIG. 3 is a flow chart of displaying processing in the image display apparatus.

FIG. 4A is a first drawing which shows the principle of re-constructing well images.

FIG. 4B is a second drawing which shows the principle of re-constructing well images.

FIG. 5A is a first drawing which shows an example of an image in the plate view.

FIG. 5B is a second drawing which shows an example of an image in the plate view.

FIG. 6A is a first drawing which shows an example of an image in the plate view when enlarged.

FIG. 6B is a second drawing which shows an example of an image in the plate view when enlarged.

FIG. 7A is a first drawing which shows the principle of creating a contour line;

FIG. 7B is a second drawing which shows the principle of creating the contour line;

FIG. 7C is a third drawing which shows the principle of creating the contour line;

FIG. 8 is a drawing which shows an example of an image in the single view.

FIG. 9A is a first drawing which shows an example of an image in the single view when enlarged.

FIG. 9B is a second drawing which shows an example of an image in the single view when enlarged.

FIG. 10A is a first drawing which shows other example of an image in the plate view.

FIG. 10B is a second drawing which shows other example of an image in the plate view.

### DESCRIPTION OF EMBODIMENT

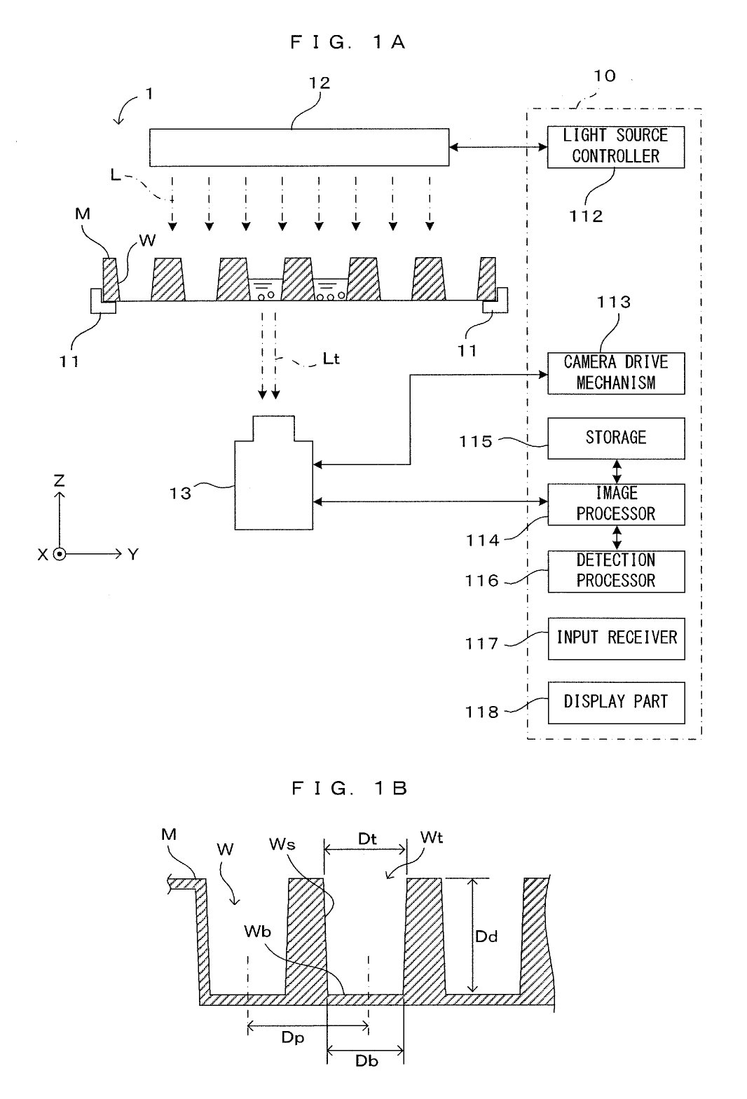

FIGS. 1A and 1B are drawings which show the schematic structure of the image display apparatus according to an embodiment of the invention. As shown in FIG. 1A, the image display apparatus 1 comprises a holder 11 which abuts on a peripheral section of the bottom surface of a sample (micro plate) M, which has a plurality of, e.g., 96 (12×8 matrix) wells W into which liquid or the like (only a part of which is shown in FIG. 1A), such as culture liquid, a culture medium and a reagent, is injected, and accordingly holds the plate M approximately horizontally, a light source 12 which is disposed above the holder 11, an image capture unit 13 which is disposed below the holder 11, and a controller 10 which controls these elements and makes these elements execute predetermined operations. For the convenience of description, the coordinate axes are set as shown in FIG. 1A. The X-Y plane is a horizontal plane and the Z axis is a vertical axis.

The diameter and the depth of the wells W of the micro plate M are typically a few millimeters. One example will now be described on the measurements of the respective parts of the micro plate M which the inventor of the invention used in an experiment. As shown in FIG. 1B, the diameter Dt of the opening Wt at the top of each well W is 6.69 mm and the inner diameter Db of the bottom surface Wb of the well is 6.58 mm. Evidently, the inner wall surface Ws of each well W is not a simple cylindrical surface and forms a shape of a taper which has slanted side surfaces. The depth Dd of each well W is 10.9 mm, and the arrangement pitch Dp among the plural wells W is 9 mm. These measurements of the respective parts are merely exemplary. The size of the micro plate handled by the image display apparatus 1 is not limited to this example but can be freely chosen.

The light source 12, under the control of a light source controller 112 disposed to the controller 10, irradiates light L upon the plurality of wells W at once from above the micro plate M which is held by the holder 11, in response to a control command received from the light source 12. The irradiation light is visible light, and preferably is white light.

The image capture unit 13 receives transmitted light Lt which is irradiated by the light source 12 and transmitted toward below by the micro plate M held by the holder 11, and thus functions as a camera which captures an image of the micro plate M. The image capture unit 13 is connected to a camera drive mechanism 113 which is disposed to the controller 10. The camera drive mechanism 113 makes the image capture unit 13 within the horizontal plane (X-Y plane) move along and scan the bottom surface of the micro plate M which is held by the holder 11.

In short, according to this embodiment, the image capture unit 13 is capable of moving along and scanning the bottom surface of the micro plate M. While the image capture unit 13 moves relative to the micro plate M in this embodiment, relative movement of the image capture unit 13 and the micro plate M to each other alone is required. In this sense therefore, the micro plate M may move relative to the image capture unit 13.

Image data captured by the image capture unit 13 are fed to an image processor 114. The image processor 114 performs image processing of the image data fed from the image capture unit 13 as needed and executes predetermined computation based upon the image data. Data before and after the processing are stored within a storage 115 as needed. A detection processor 116 performs predetermined detection processing based upon the image data received from the image processor 114 and detects a characteristic area included in an image. This detection processing is processing in which luminance data of an image are analyzed for example to thereby detect an area within this image where an optical characteristic is different from that of a surrounding area. In addition, the feature value is calculated with respect to this area so that it is possible to classify the origin and the type of this area. With respect to the processing for distinguishing and detecting a segment which has a certain characteristic from an image and a suitable feature value to such processing, various types of techniques are known and therefore will not be described here in detail.

The result of detection performed by the detection processor 116 is also stored in the storage 115. As described later, the image processor 114 may perform image processing based upon the result of the detection processing performed by the detection processor 116 as needed. The image data which were appropriately processed are fed to a display part 118 which comprises a display device such as a liquid crystal display, and the display part 118 shows an image which corresponds to the image data and presents it to a user. This image display apparatus 1 comprises an input receiver 117 which accepts an operation command which a user gives as for the content of image processing, the mode for displaying, etc. The input receiver 117 is input receiving device, such as a key board, a mouse and a touch pad, or appropriate combination of them. The input receiver 117 accepts a command from a user, and as the controller 10 reflects the command in an operation of the apparatus, whereby a function desired by a user is realized.

This image display apparatus 1 is applicable to capturing of an optical image of a sample to be imaged such as liquid or the like held in the wells W and a cell or the like contained in the liquid or the like and is applicable to detection from the optical image of a unique section which has a predetermined optical characteristic, i.e., a different optical characteristic from that of the liquid or the like held in the wells W, utilizing the difference of the optical characteristic. For instance, the apparatus is applicable to capturing of an image of a cell or cell cluster (spheroid) contained in culture liquid, a culture medium or the like as a sample to be imaged and to automatic detection of the cell or the like by the image processing. The expression “liquid or the like” used herein collectively refers to liquid, gel-like or semi-fluid solid matter and substances which are injected as they are fluid into the wells and solidify afterward like soft agar for instance.

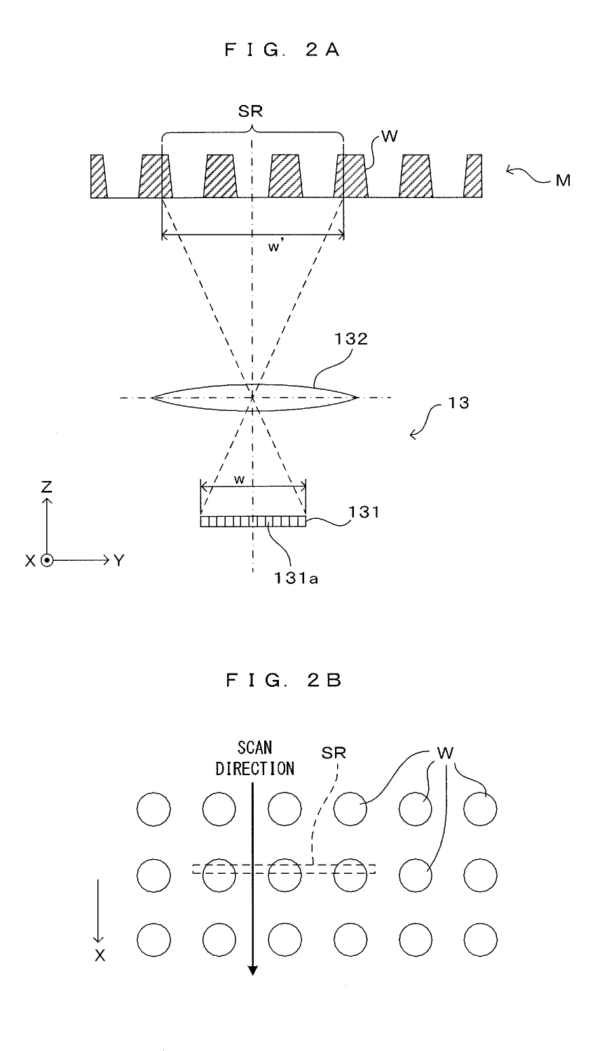

FIGS. 2A and 2B are drawings which show the more detailed structure of the image capture part. As shown in FIG. 2A, the image capture unit 13 comprises a line sensor 131 formed by a CCD for instance which outputs an electric signal in accordance with incident light and an imaging optical system 132 which makes outgoing light from the bottom surface of the micro plate M which is held by the holder 11 focused as an image on the light receiving surface of the line sensor 131. The imaging optical system 132 may comprise a plurality of optical components such as a lens, and for the purpose of easy understanding, is represented as a single lens in FIGS. 2A and 2B.

The line sensor 131 has a one-dimensional arrangement of a number of very small imaging elements 131a in the Y direction, and is constructed so that its imaging range SR encompasses at least one well W as a whole or preferably a plurality of wells (three wells in FIGS. 2A and 2B) W all at once via the imaging optical system 132 along the longitudinal direction. In FIGS. 2A and 2B, the length of the line sensor 131 along the Y direction is denoted at the reference symbol w and the length of the visual field in the Y direction at the bottom surface of the micro plate M is denoted at the reference symbol w′.

Further, as shown in FIG. 2B, the scan direction in which the line sensor 131 scans as driven by the camera drive mechanism 113 is the X direction. As the line sensor 131 in which the imaging elements are arranged along the Y direction scans in the X direction along the bottom surface of the micro plate M described above, a two-dimensional image of the micro plate M as viewed from the bottom surface side can be captured. Further, as the scan movement above is repeated while the Y-direction location of the line sensor 131 is changed, it is possible to capture images of the number of wells W formed on the micro plate M one after another.

The line sensor 131 can capture a high-resolution image since the pixel size of each imaging element is small. The number of imaging elements are arranged in a line-like arrangement, the imaging optical system 132 is structured so that optical images of the wells W are focused at the imaging elements, the locations of the imaging elements and the imaging optical system 132 are appropriately arranged, thereby causing light from one or more wells W to impinge upon the line sensor 131. This shortens the time which is necessary to shoot one well W. In this manner, it is possible to capture images of the number of wells W at a high speed. Once an image of the micro plate M as a whole is acquired in advance, captured images are then processed by predetermined processing and displayed in various display modes described below, so that various images are presented to a user in accordance with user's purposes.

In the image display apparatus 1 which has the structure described above, the image capture unit 13 captures an image of each well W of the micro plate M in response to an operation command given from a user via the input receiver 117, the image processor 114 and the detection processor 116 perform image processing and detection processing designated by a user based upon the image data, and the display part 118 displays the result. When a user's command to shoot an image is received, the controller 10 performs a series of processing described below, thereby the function above is realized.

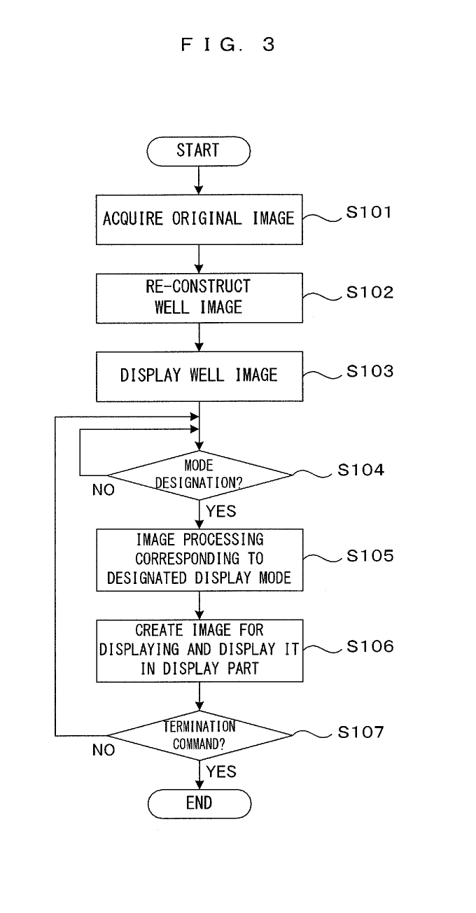

FIG. 3 is a flow chart of a displaying process in the image display apparatus. As a user gives a command to shoot an image, the image capture unit 13 operates to capture an image of the entire micro plate M, whereby original images of all wells W are acquired (Step S101). The image obtained by scanning the micro plate M as a whole contains the images of all wells W as partial images. Of this image, a portion of the surface of the micro plate M other than the wells W is unnecessary and wasteful from the perspective of effective use of the display space of the display part 118. The images corresponding to the wells W alone are extracted from thus obtained image and sorted, which achieves image re-construction (Step S102).

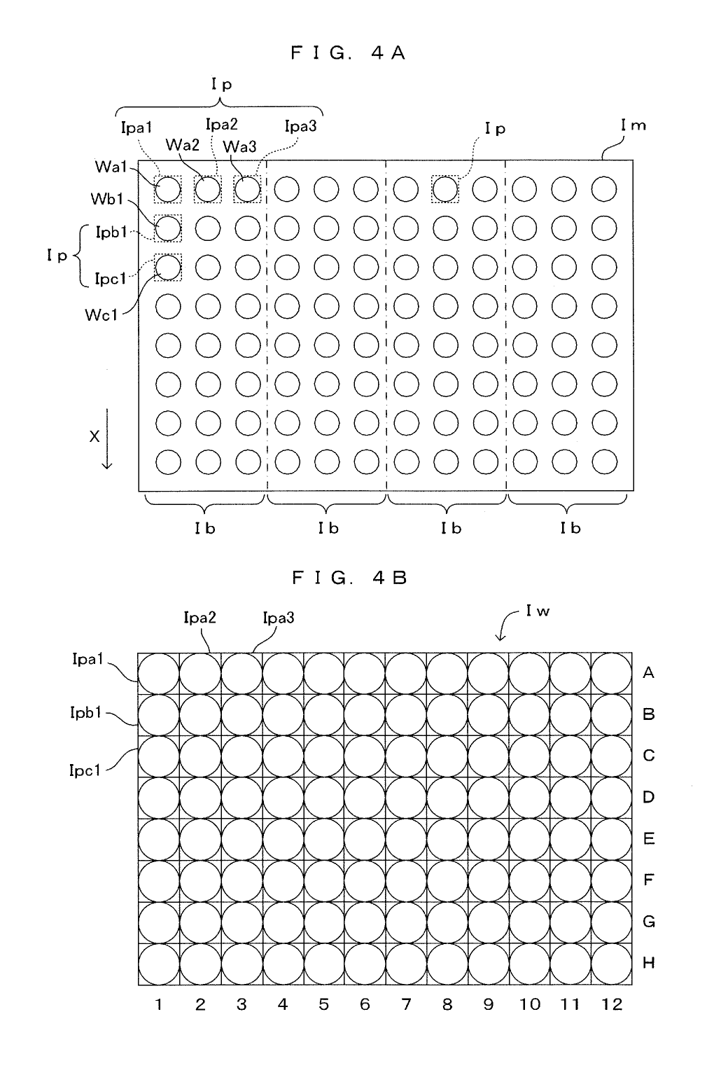

FIGS. 4A and 4B are drawings which show the principle of re-constructing the images of the wells. As shown in FIG. 4A, the image Im of the micro plate M as a whole comprises a plurality of band images Ib which were captured as the image capture unit 13 scanned relative to the micro plate M. From the total image Im, the partial images Ip alone corresponding to the wells W in the matrix arrangement are cut out, and as shown in FIG. 4B, the well image Iw re-constructed by arranging the partial images Ip thus cut out is obtained. Since the diameter and the arrangement pitch of the wells W formed on the micro plate M are known, it is possible to identify areas corresponding to the respective wells W based upon the coordinate locations within the total image Im for example. The areas corresponding to the respective wells W are like approximately circles the sizes of which are known, and therefore, it is possible to identify the areas corresponding to the respective wells W also by extracting areas which satisfy this condition through image analysis.

The partial images Ip may be images which are obtained by cutting out only the approximately circular areas which correspond to the wells W, or may be images which are cut out using rectangles which contain the circular areas which correspond to the wells W as shown in FIG. 4A. In the case of the latter, the partial images Ip as desired are obtained by cutting out areas one side of each one of which is approximately equal to the diameter of each well W and the center of each one of which is the location of the center of gravity of each well W, namely, square areas which are circumscribed the circular areas corresponding to the wells W.

The wells W within the re-constructed well image Iw are located so as to have the same positional relationship as that of the wells in the total image Im, namely, the positional relationship of the wells W on the actual micro plate M. In other words, in the total image Im shown in FIG. 4A, wells Wa1, Wa2, Wa3, . . . are lined up in order toward the right-hand side from the upper left corner, and the wells Wa1, Wb1, Wc1, . . . are lined up toward below from the upper left corner. As shown in FIG. 4B, in the re-constructed well image Iw as well, the partial images Ipa1, Ipa2, Ipa3, . . . corresponding to the wells Wa1, Wa2, Wa3, . . . are arranged so as to line up toward the right-hand side from the upper left corner, and the partial images Ipa1, Ipb1, Ipc1, . . . corresponding to the wells Wa1, Wb1, Wc1, . . . are arranged so as to line up toward below from the upper left corner.

The partial images Ipa1, Ipa2, Ipa3, . . . cut out from the total image Im are respectively treated as original images in the unit of wells which correspond to the wells Wa1, Wa2, Wa3, . . . , respectively. The locations on the micro plate M are assigned as index information to the original images in the unit of wells Ipa1, Ipa2, Ipa3, . . . . Describing more specifically, row indices 1 through 12 are assigned to the wells which are lined up sideways (the row direction) shown in FIG. 4B. To the wells arranged in the vertical direction (the column direction), column indices A through H are assigned. It is therefore possible to identify each well by combination of the alphabetic indices A through H and the numerical indices 1 through 12. As the partial images are arranged and the image is re-constructed based upon this index information, the well image Iw is created which is exclusive of “the blank area” which needs not be observed, namely, the surface area of the micro plate M other than the wells, while maintaining the positional relationship of the wells W.

The display processing will be continuously described, referring back to FIG. 3. Thus created well image Iw is displayed by the display part 118 in its entirety (Step S103). This allows a user to generally confirm the captured images. This state is maintained as stand-by until a user provides a command regarding the display mode (Step S104). While various modes may be used as the display modes which are effective in helping a user observe the wells W, only some of them will now be described.

The first factor relevant to the display modes is whether to display all of the plurality of wells W arranged on the micro plate M or to display the wells W individually. One of the purposes of using the apparatus of this type is to display within the same screen images of a plurality of samples which were prepared while gradually changing a condition from one well W to another for example and comparing the images with each other. A display mode for simultaneously displaying images which correspond to the plurality of wells W is necessary for such a purpose. In the event the arrangement of the wells W in the image which is displayed at this stage matches with the actual arrangement on the micro plate M, a user can easily grasp the relationship among the wells W. On the contrary, when the total image Im of the micro plate M which was shot is displayed as is, the blank area other than the wells on the micro plate M deteriorates the efficiency of utilizing the display area.

Noting this, this embodiment ensures that it is possible to cut out the partial images Ip corresponding to the wells W from the total image Im of the micro plate M and display the well image Iw which is obtained by arranging the partial images in the same arrangement as that on the micro plate M. This mode of displaying is referred to as “the plate view” in this description. In the plate view, it is not required to display all of the wells W all times: rather, as needed, only some wells W may be displayed while maintaining the arrangement of these wells as it is.

In the meantime, more detailed observation of the image of each well W is also wanted and therefore a function for allowing a user to choose any desired well W and displaying the chosen well alone is necessary. This mode of displaying is referred to as “the single view” in this description. In the single view, preferably it is possible to display at least two wells for the purpose of observing only one well W and for the purpose of comparing and observing more than one freely chosen wells.

The second factor relevant to the display modes is a magnification rate for images. Depending upon the purpose, a user may want to take an overall view of an entire image or enlarge and see only a part of the image. It is therefore preferable that a function for enlarging or shrinking an image at a desired magnification rate and displaying is provided.

The third factor relevant to the display modes is directed to the mode of image processing of an image which needs be displayed. In addition to merely displaying a captured original image as it is, analyzing the image, attaching various types of information based on the analysis result to the image and thereafter displaying the image more effectively helps a user observe the image.

Various image analysis techniques to the effect above are known and applicable to the embodiment. For example, a classification technique for classifying various objects contained in an image according to an optical or geometrical characteristic is applicable. The feature value of an object may be calculated and classification may be performed based upon the calculated feature value. As the classification criterion, the size, the density and the surface area size of the object, the diameter of the circumscribed circle of the object, the volume of the circumscribed sphere of the object, the cell type and the like presumed from these may be used solely or in appropriate combination with each other.

As a method of reflecting the analysis result in the image, various types of visually distinguishable information (visual information), such as color coding realized by changing the color information of the image, hatching, filling in, change of the brightness, contour enhancement, attachment of a hem or pointer and attachment of text information, may be added solely or in appropriate combination with each other.

In the image display apparatus 1 according to this embodiment, as a user's command designates one of the plurality of display modes which are specified by combination of the three types of factors above (Step S104), necessary image processing for the purpose of displaying in the designated display mode is executed (Step S105). More specifically, various types of analysis and classification of the image to be displayed of the partial images Ip corresponding to the wells W and image processing of this image based upon the analysis and classification result are executed by the image processor 114 and the detection processor 116.

Using thus processed partial images as material images, the image processor 114 creates an image for displaying in which the material images are arranged in a predetermined arrangement and at a predetermined magnification rate inside the display area, and the display part 118 displays the image for displaying (Step S106). This state continues until a new command from the user is received (Step S107) and the processing ends if a termination command is received, while the processing responding to a new command is executed if the new command designating the mode is received.

Next, examples of images for displaying in the display modes which are executable in the displaying processing designed as described above will now be described. The examples are related to application of the apparatus according to the embodiment to a cell observing apparatus which is used to observe objects which are cells or groups of cells (cell clusters) which were cultured within wells while regularly changing a culture condition (i.e., the concentration of a chemical agent injected to a culture medium) from one cell to another.

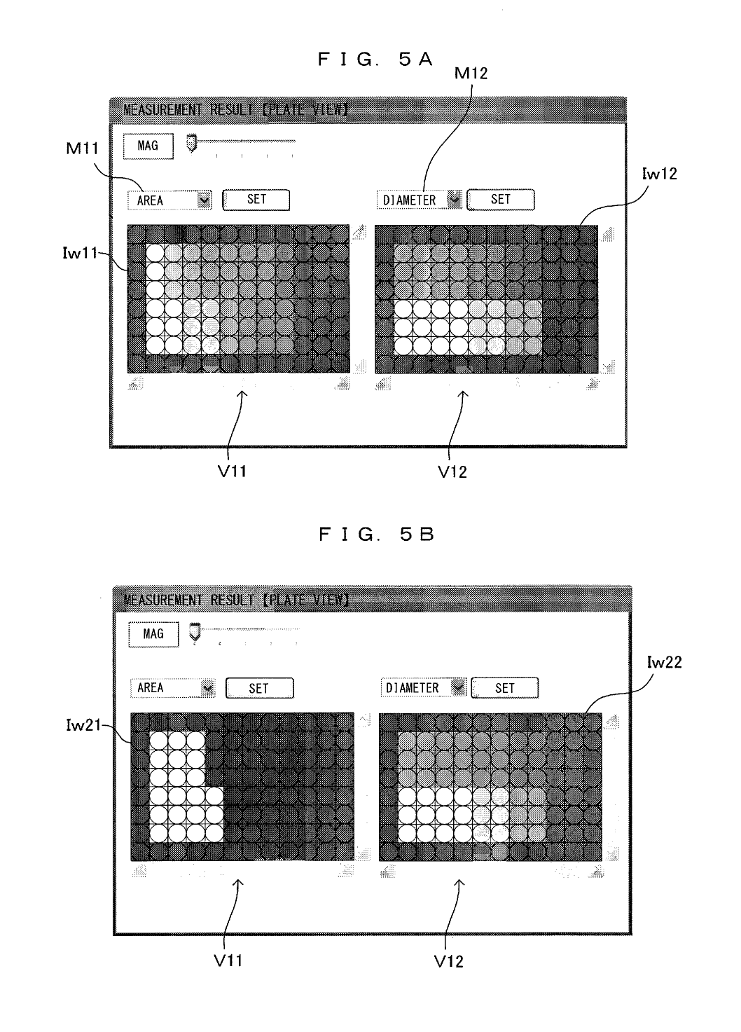

FIGS. 5A and 5B are drawings of examples of images in the plate view. An experiment of this type often involves work of regularly changing the concentration of a chemical agent from one well to another in accordance with the arrangement of the wells and observing thus created samples. In the plate view which is for displaying the plate as a whole, the visibility of the well arrangement is important as described earlier.

FIG. 5A shows one example of a plate view image which corresponds to the micro plate which has 96 holes (12 holes×8 columns). In two view areas V11 and V12 at the center of the screen, well images Iw11 and Iw12 each including all wells are displayed respectively. Each well is not displayed as an original image but is displayed as it is color coded (in the gray scale in FIG. 5A) in accordance with the result of classification based upon a designated criterion. While the well images Iw11 and Iw12 displayed in the two view areas V11 and V12 correspond to the same image of the same micro plate, since the designated classification criteria are different from each other, what is displayed becomes different from each other in general.

Specifically, the well image Iw11 displayed in the left-hand side view area V11 is color coded in accordance with the result of classification which uses the surface area size of an object contained in each well as a criterion parameter, as indicated in a menu field M11 which is above the view area V11. That is, the image processor 114 and the detection processor 116 calculate the surface area sizes of objects contained in each well, and each well is filled in and painted in a color which is assigned according to largeness of the average value of the calculated surface area sizes of the objects contained in each well. On the other hand, the well image Iw12 displayed in the right-hand side view area V12 is color coded in accordance with classification which uses the diameter of an object contained in each well (i.e., the diameter of the circumscribed circle of the object), as indicated in an upper menu field M12.

In such a display mode, it is possible to present to a user an image in which the user can easily visually recognize a general trend of changes of the shapes of the objects (cell clusters) which occur among the wells as the concentration of the chemical agent changes. Further, the two well images are displayed side by side which show the same object to be image-captured which was classified based upon the different criteria, thereby realizing an environment which permits the user to efficiently observe images.

Thus, for overall observation of the plate as a whole, displaying various structures contained in an image of each well in detail could deteriorate the visibility by contraries. Hence, the embodiment uses a display method of filling in each well in a color which is according to the average value of a parameter within the well designated as a classification criterion. This may be replaced with color coding the background of each well in accordance with the value of the criterion parameter.

Manipulating as needed various setup functions displayed on the screen, a user can switch an image for displaying in various manners. In short, when using the menu field M11 or clicking a “SET” button on the screen, a user can retrieve various setup menus and perform setting up. When manipulating a “MAG” button, the user can increase or decrease the image displaying magnification rate. When a new display mode is designated in this fashion, the processing at and after Step S105 shown in FIG. 3 is executed again, whereby an image is displayed in the designated display mode. For instance, in the example in shown in FIG. 5B, the well image Iw21 displayed in the left-side view area V11 is an image which is obtained by binarization of the surface area size of an object using a predetermined threshold value. It is possible to set up whether to display a multi-value image or a binary image, how to set up the threshold value for binarization, etc., using the setup menus.

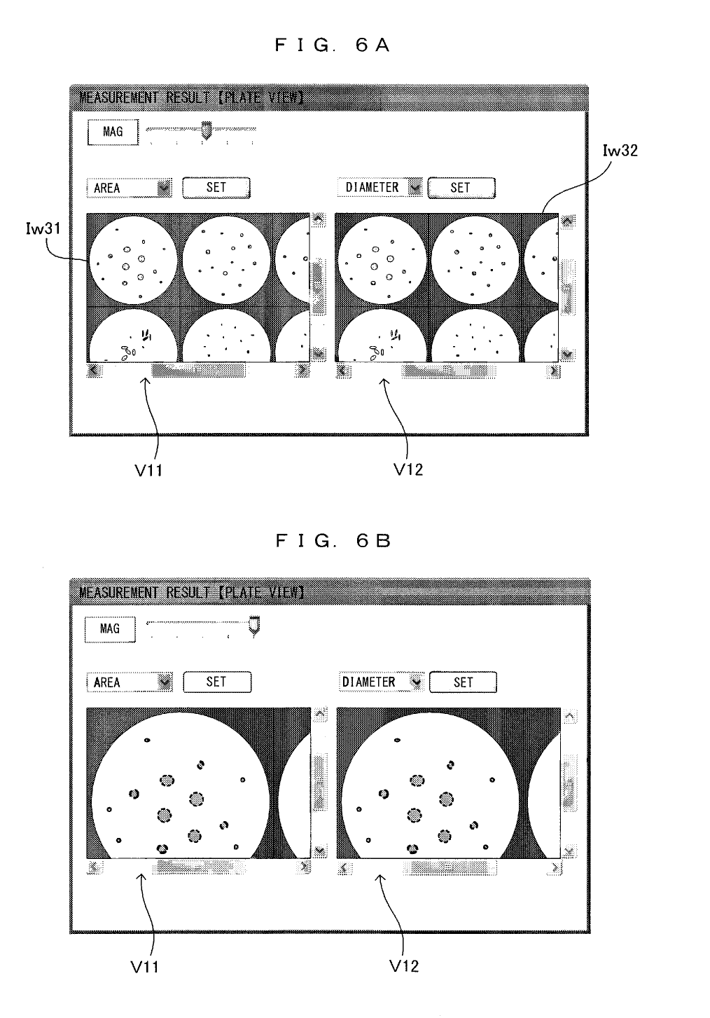

FIGS. 6A and 6B are drawings of examples of images in the plate view when enlarged. While the example in FIG. 6A is premised upon a medium level rate of magnification (which may for instance be 5 power), a user can freely set the magnification rate by manipulating an operation bar (MAG bar) which is displayed above the images. At this stage, the same magnification rate may be applied to both of the enlarged well images Iw31 and Iw32 which are displayed in the two view areas V11 and V12. The relationship among the locations of the wells is maintained in the enlarged images as well.

In the event that it becomes impossible to display the entire well images as the images are enlarged, the well images are partially enlarged and displayed in the view areas V11 and V12 and an operation bar (scroll bar) is displayed outside the view areas so that it is possible to move the display ranges inside the well images. At this stage, the enlarged well images Iw31 and Iw32 always show the same ranges as those within the original well images. That is, when the scroll bar is manipulated in one of the images, the display ranges within the two enlarged well images Iw31 and Iw32 accordingly change at the same time.

In the enlarged well images within which the wells are shown in relatively wide areas, filling in in the unit of wells is not performed: the objects contained in the respective wells are color coded, hatched or otherwise appropriately processed based upon a classification criterion.

In such a display mode, it is possible to provide to a user an environment which permits comparison of the wells which are located close to each other (i.e., which have slightly different creation conditions) while observing the distribution of the objects in each well in detail. As it is possible to continuously change the display ranges and the magnification rate using the manipulation bars, it is easy to compare and observe the wells.

At this stage, as the both enlarged well images Iw31 and Iw32 are related with each other such that the magnification rate for enlarging these two images and the display ranges within the entire well images match, the paired wells to be compared with each other are displayed in the unchanged positional relationship. This makes it possible for a user to observe the wells while always comparing analysis results with each other which were obtained using different criteria.

The example in FIG. 6B is an example of an image in the plate view when the magnification rate for enlarging is the largest. The magnification rate is selected so that one well generally fits in each one of the view areas V11 and V12. In this display mode, objects within the well are displayed as they maintain the colors of corresponding original images and only the contour lines of the objects are color coded based upon a classification criterion (In FIG. 6B, depending on the pitches of the dots of dotted lines, the colors of the contour lines are different.). The contour lines of the objects may be created in the following manner for instance.

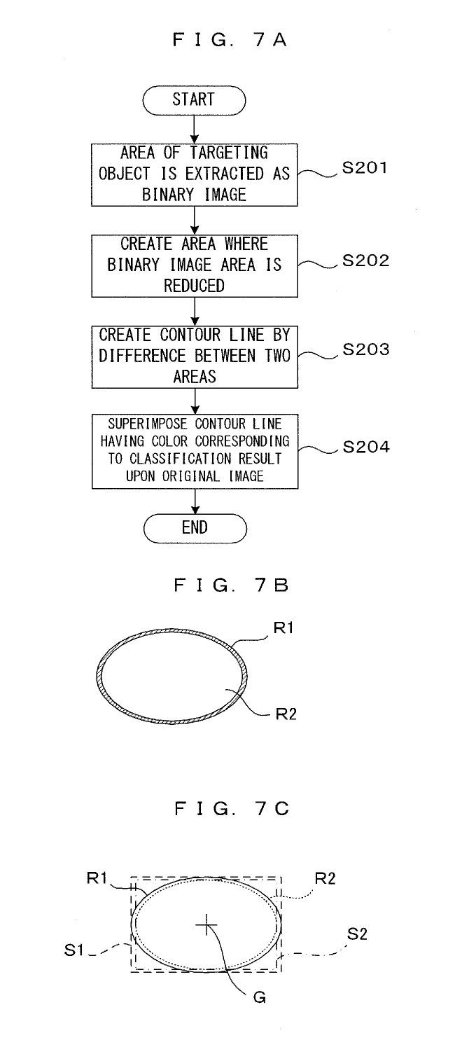

FIGS. 7A through 7C are drawings which show the principle of creating contour lines. FIG. 7A is a flow chart which shows creation process of a contour line. With respect to an object for which a contour line needs be created inside an image, the area of the object within the image is extracted as a binary image (Step S201). As a result, the area of the object is filled in with a predetermined pixel value. Following this, the area extracted as a binary image is subjected to erosion processing in morphology processing for example to thereby reduce by a predetermined number of pixels (Step S202). The number of pixels for reduction is preferably chosen to take a sufficiently small value relative to the size of this area so that the shape of the area itself will not largely change, and may therefore be one pixel for instance.

This is followed by subtraction of the reduced area R2 from the original binary image area R1 as shown in FIG. 7B (Step S203). This offsets pixel values within the overlapping section of the two areas R1 and R2 but leaves within a circumferential part a periphery portion of the original image area R1 which is equivalent to the number of pixels which were reduced (i.e., the hatched portion in FIG. 7B). The portion thus left is synthesized with the original image and superimposed upon the object as the contour line of the object (Step S204), which makes it possible to enhance and display the contour of the object. The color of the portion which corresponds to the contour line is chosen in accordance with a characteristic of the object, whereby the classification result is reflected in the image.

For the purpose of accurately laying the object and the contour line within the original image one atop the other, it is important that the posture and the location of the area of the object in the original image, the corresponding binary image area and the reduced image area are aligned to each other. For this purpose, as shown in FIG. 7C for example, imaginary rectangles S1 and S2 respectively circumscribing the image areas R1 and R2 may be set and the image areas may be laid one atop other so that the centers of gravity G of the rectangles S1 and S2 match with each other and the corresponding sides of the rectangles S1 and S2 are parallel to each other.

The foregoing has described the function of the plate view which is for displaying the plurality of wells W in the same arrangement as that on the micro plate M. In the plate view, a user can observe the wells with a similar operability to that for direct observation of the micro plate M. In addition, it is possible to observe from various perspectives since classification results obtained using different criteria are displayed side by side. When an image is enlarged and a part of a total image is displayed, in the two view areas, the magnification rates for images and the display ranges behave in a concerted manner with each other. In consequence, two types of classification results are always presented with respect to the portion to be observed, which realizes efficient observation. Further, as the mode of visual information assigned to the image automatically changes in accordance with a change of the magnification rate, it is easy to visually recognize each well or the state of an object contained in each well within the image at each magnification rate.

Next, “the single view” function will be described which is for displaying only an image of a particular well selected by a user from among the wells W. At Step S104 in FIG. 3, as a user chooses the single view as the display mode and selects a well to be displayed, a single view display screen like the one described below is displayed.

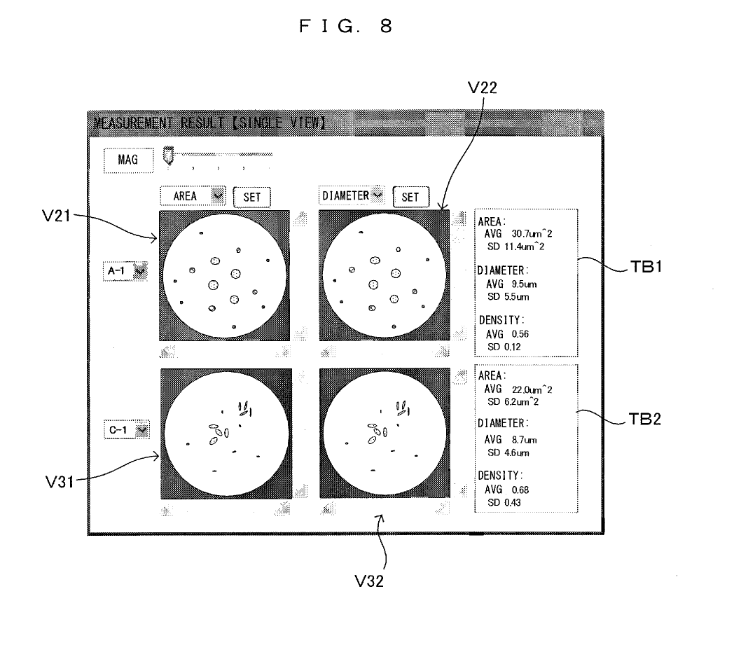

FIG. 8 is a drawing of an example of an image in the single view. In the single view display screen, four view areas V21, V22, V31 and V32 are displayed in a matrix of 2×2, and in each view area, one partial image Ip which corresponds to one well is displayed. Of these, within the upper two view areas V21 and V22, images indicative of the results of classification of the same well using different criteria (which are the surface area size and the diameter of an object in this example), specifically, images containing objects color coded in accordance with the value of a criterion parameter are displayed. As indicated by a pull-down menu box on the left to the view area V21, the well displayed in this area is the well which is specified by index information “A-1,” i.e., the well which corresponds to the well Wa1 which is located on the upper left corner within the plate image Ip shown in FIG. 4A. Manipulating the pull-down menu, a user can change the well to display.

Displayed in the lower view areas V31 and V32 are images which are obtained by reflecting classification results using the criteria of the surface area size and the diameter of objects in the original image which corresponds to a different well (the well Wc1 specified by index information “C-1” In this example) from the well mentioned above. In short, in this display mode, the images indicative of the classification results of the same well obtained using the different criteria are displayed side by side in the horizontal direction, whereas the images indicative of the classification results of the different wells obtained using the same criterion are displayed side by side in the vertical direction.

At the far-right of the upper and the lower rows, text boxes TB1 and TB2 which indicate analysis results in the corresponding wells using numerical values are located. In this example, the text box TB1 in the upper row shows statistical information (the average values and the standard deviation (SD) values) of parameters concerning all objects, namely, the surface area size, the diameter and the density, detected in the selected well Wa1 in the upper row. Meanwhile, in the text box TB2 in the lower row, similar statistical information for the selected well Wc1 in the lower row is displayed. Text information to be displayed is not limited to this but may be freely determined.

In this display mode, a user can observe the images while comparing the classification results of the two wells which were obtained using the two criteria per well. It is also possible to observe while appropriately switching the well to display, the classification criteria, etc., by manipulating the menu boxes. Further, it is possible to obtain detailed information regarding the respective wells from the text information which is displayed in the text boxes. According to the embodiment, it is thus possible to efficiently observe the wells in detail while comparing in particular the different wells with each other or classification results of the same well obtained using different criteria.

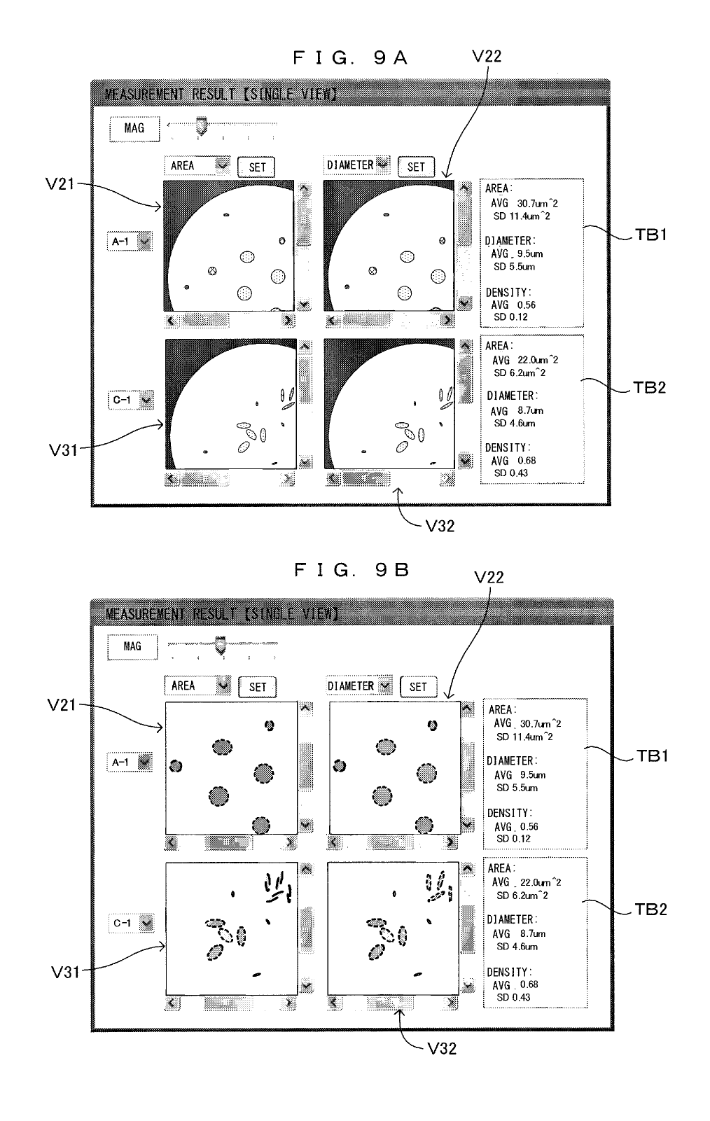

FIGS. 9A and 9B are drawings of examples of images in the single view when enlarged. FIG. 9A shows an example that a medium enlarging magnification rate (of 5 power for instance) is selected and FIG. 9B shows an example that the maximum magnification rate is selected. Like the plate view, in the single view as well, it is possible to appropriately change the magnification rate for images, and in the event that a well as a whole does not fit in the display ranges, the display ranges in the respective view areas works in coordination. In addition, the mode of visual information attached to images for indicating classification results is automatically changed in accordance with a change of the displaying magnification rate. Owing to these displaying functions, a user can simultaneously observe image processing results of the same well which were obtained using different criteria or image processing results of different wells which were obtained using the same criterion. Statistical information displayed in the text boxes TB1 and TB2 is indicative of analysis results of one well as a whole and does not change when the displaying magnification rate changes.

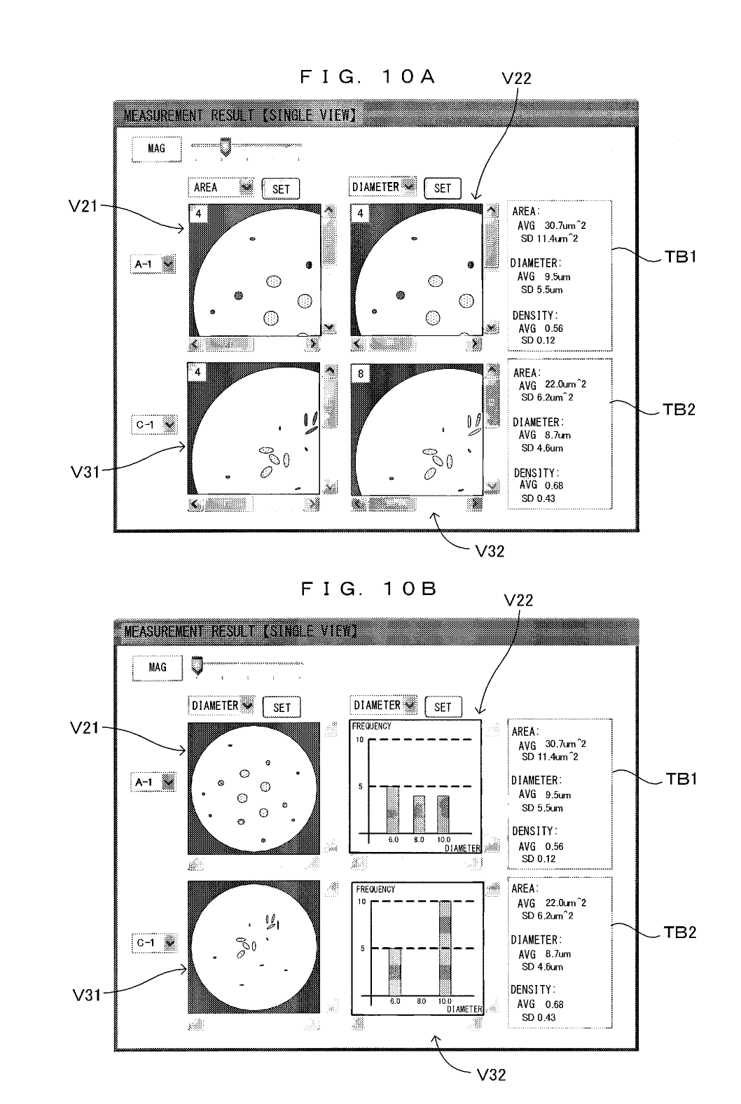

FIGS. 10A and 10B are drawings of other examples of images in the single view. In the example in FIG. 10A, in addition to the content shown in FIG. 9A, the number of detected objects which meet a conformity condition designated by a user is displayed on the upper left corner within each view area. For instance, a threshold value set by a user may be accepted as for a classification criterion and the number of objects which take a value which is equal to or larger than the threshold value may be displayed. In such a display mode, it is possible to efficiently assist a user in searching for an object which satisfies a predetermined condition set by the user.

In the example in FIG. 10B, within the view areas V21 and V31 on the left-hand side of the upper and the lower rows, images to which classification results obtained using “the diameter” as a classification criterion are attached as above-mentioned visual information are displayed, while within the view areas V22 and V32 on the right-hand side, classification results based upon the same classification criterion (the diameter) are displayed in the form of histogram. A histogram is indicative of an analytical result of one well as a whole and is not influenced by the displaying magnification rate. In such a display mode, a user can confirm how objects which satisfy a predetermined condition are distributed within each well, the rate of occurrence of such objects, etc., on the same screen.

As described above, the image display apparatus according to the embodiment is for the purpose of observing a biological sample such as a cell and a cell cluster for instance, and is equipped with various displaying functions which make it possible for a user to compare a plurality of images with each other and observe the images.

That is, the plate view function which is for displaying the wells W on the micro plate M in summary achieves as the various display functions:

(1) that images of well sections to be observed are extracted from original images which were obtained as the image capture unit scanned the micro plate and the extracted images are displayed in an arrangement which is in line with the arrangement on the micro plate;
(2) that visual information (such as color coding) in accordance with a classification result obtained using a classification criterion designated by a user is attached to each well and displayed;
(3) that a user can designate and change the mode of attaching the visual information;
(4) that two types of classification results based on different classification criteria are displayed side by side in the two view areas on the screen;
(5) that images can be enlarged and the displaying magnification rates and the display ranges in the two view areas are the same (i.e., when a user changes one rate or range, the other rate or range is changed automatically);
(6) that in the case of enlarged images, visual information based upon a classification result is attached to objects contained in wells; and
(7) that in accordance with a designated displaying magnification rate, visual information to be attached to a well or object is changed automatically.

Further, the single view function which is for, displaying the individual wells W separately realizes:

(1) that visual information based upon a classification result is attached to an object contained within a well and displayed;
(2) that the mode of attaching visual information can be changed as designated by a user;
(3) that a user can designate a well to display and a plurality of designated well images can be displayed side by side in a plurality of view areas;
(4) that the plurality of well images include those images which are indicative of classification results of the same well which were obtained using different classification criteria or those images which are indicative of classification results of different wells which were obtained using the same classification criterion;
(5) that images can be enlarged and the displaying magnification rates and the display ranges in the plurality of display areas are the same;
(6) that in accordance with a designated displaying magnification rate, visual information to be attached to an object is changed automatically; and
(7) that numerical data concerning a classification result are displayed as text information, a graph, etc.

In the embodiment, these various types of displaying functions make it possible to present to a user an environment in which the user can efficiently observe samples from various perspectives. To be noted in particular, it is easy to compare between different wells and compare analysis results of the same well which are obtained from different perspectives. This is preferably useful for a chemical sensitivity test of cell for instance and otherwise appropriate occasions in which to observe at the level of cell clusters is more meaningful than to observe each cell, the internal structure of the cell, etc.

As described above, in the embodiment, the micro plate M corresponds to the “sample holding plate” of the invention and each well W corresponds to each “recess portion” of the invention. Further, of the total image Im of the entire plate, the partial images Ip which correspond to the wells correspond to the “original images” of the invention, and images resulting from image processing of the partial images correspond to the “material images” of the invention. The images shown in FIGS. 5A, 5B. 6A, 6B and 8 through 10B including the material images correspond to the “image for displaying” of the invention.

In the embodiment, the detection processor 116 is equipped with a function as the “specific segment detector” and the “feature value calculator” of the invention, the image processor 114 functions as the “visual information attaching part” of the invention, and these elements when working together function as the “image processor” of the invention.

Further, in the embodiment, the input receiver 117 functions as the “receiver” of the invention, and the display part 118 functions as the “display element” of the invention. The image capture unit 13 functions as the “imager” of the invention.

In the displaying processing according to the embodiment shown in FIG. 3, Steps S104, S105 and S106 respectively correspond to the “receiving step,” the “image creating step” and the “displaying step” of the invention.

The invention is not limited to the embodiment described above but may be modified in various manners in addition to the embodiments above, to the extent not deviating from the object of the invention. For instance, the embodiment above is directed to the image display apparatus which comprises the image capture unit which captures images of the wells which are formed on the micro plate. However, as described above, since the displaying processing of the embodiment aims at processing an image of the entire micro plate in various manners and accordingly helping a user observe, it is not necessary to capture an image once again even after the display mode is changed. In this sense, the image capture element is not mandatory: the invention is applicable also to an apparatus which receives, using proper telecommunication device, image data captured by other image capture apparatus for example, processes and displays the image data.

Further, while the embodiment above requires classifying an object contained in a well based upon a criterion which is primarily related to the shape, e.g., the surface area size or the diameter of the object, the classification criterion is not limited to such: various classification criteria used for observation of a cell, a biological tissue, etc. may be used. For instance, a cell type may be comprehensively determined from the shape, the color, the size and the like of an object and different cell types may be differently color coded. In addition, a criterion obtained by studying cases on known samples may be used.

Further, while the embodiment above realizes image capturing by moving the line sensor 131 which is formed by a one-dimensional arrangement of the imaging elements relative to the micro plate M, a CCD array which is formed by a two-dimensional arrangement of imaging elements may be used for image capturing.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

### INDUSTRIAL APPLICABILITY

The invention is particularly preferably applied to the field in which samples held in a number of wells need be observed, for example, a micro plate which is used in the field of medicines and bio science. However, the application of the invention is not limited to the field of medicines and bio science.

### REFERENCE SIGNS LIST

13: image capture unit (imager)
114: image processor (visual information attaching part, image processor)
116: detection processor (specific segment detector, feature value calculator, image processor)
117: input receiver (receiver)
118: display part (display element)
Ip: partial image (original image)
M: microplate (sample holding plate)
S104: receiving step
S105: image creating step
S106: displaying step
W: well (recess portion)

1. An image display apparatus which displays images of a plurality of recess portions for holding samples which are arranged on a sample holding plate, comprising:
an image processor which creates material images by treating an original image obtained by imaging one of the recess portions with image processing for attaching visual information corresponding to the content of the original image to the original image and creates an image for displaying in which a plurality of the material images which are different from each other are arranged; and
a display element which displays the image for displaying,
wherein the image for displaying contains at least one of a set of the plurality of material images obtained by treating a plurality of the original images each of which corresponds to each recess portion and which are different from each other with the same image processing and a set of the plurality of material images obtained by treating the same original image with different image processing.

2. The image display apparatus of claim 1, comprising a receiver which receives a user's command which demands at least one of selection of the material images and selection of the content of the image processing,
wherein the image processor creates the image for displaying which corresponds to the command fed to the receiver.

3. The image display apparatus of claim 1, wherein the image processor comprises:
a specific segment detector which detects a specific segment exhibiting a particular optical characteristic within the original image;
a feature value calculator which calculates a feature value of the detected specific segment; and
a visual information attaching part which attaches to the original image the visual information corresponding to the calculated feature value.

4. The image display apparatus of claim 3, wherein the visual information attaching part attaches the visual information which corresponds to the feature value calculated as for the specific segment to a location which corresponds to the specific segment within the original image.

5. The image display apparatus of claim 3, wherein the image processor creates the image for displaying which contains the plurality of material images which are obtained by attaching the visual information based upon the mutually different feature values to the same original image.

6. The image display apparatus of claim 1, wherein the image processor creates the image for displaying in which the plurality of material images corresponding to the mutually different recess portions according to the sequence of the recess portions on the sample holding plate.

7. The image display apparatus of claim 1, wherein the image processor is capable of changing and setting a magnification rate for displaying the material images within the image for displaying, and changes the visual information which is attached to the material images in accordance with the set magnification rate.

8. The image display apparatus of claim 1, wherein the image processor creates the image for displaying which contains the plurality of material images which are obtained by treating the same single partial area within the same original image with different image processing.

9. The image display apparatus of claim 1, wherein the image processor creates the image for displaying which contains the material images and text information concerning the contents of the material images.

10. The image display apparatus of claim 1, comprising an imager which makes an image capture element move relative to and scan the sample holding plate and accordingly captures the original image.

11. An image display method for displaying images of a plurality of recess portions for holding samples which are arranged on a sample holding plate, comprising:
an image creating step of creating material images by treating an original image obtained by imaging one of the recess portions with image processing for attaching visual information corresponding to the content of the original image to the original image, and of creating an image for displaying in which a plurality of the material images which are different from each other are arranged within a same frame; and
a displaying step of displaying the image for displaying,
wherein the image for displaying contains at least one of a set of the plurality of material images obtained by treating a plurality of the original images each of which corresponds to each recess portion and which are different from each other with the same image processing and a set of the plurality of material images obtained by treating the same original image with different image processing.

12. The image display method of claim 11, comprising a receiving step of receiving a user's command which demands at least one of selection of the material images and selection of the content of the image processing, wherein at the image processing step, the image for displaying which corresponds to the command fed at the receiving step is formed.

13. The image display method of claim 11, wherein an image of the recess portion, which holds transparent liquid or gel containing a cell or microorganism as the sample, is used as the original image.

14. The image display apparatus of claim 2, wherein the image processor comprises:
a specific segment detector which detects a specific segment exhibiting a particular optical characteristic within the original image;
a feature value calculator which calculates a feature value of the detected specific segment; and
a visual information attaching part which attaches to the original image the visual information corresponding to the calculated feature value.

15. The image display method of claim 12, wherein an image of the recess portion, which holds transparent liquid or gel containing a cell or microorganism as the sample, is used as the original image.
